(19) United States
(12) Patent Application Publication
(10) Pub. No.: US 2012/0124825 A1
(43) Pub. Date: May 24, 2012

(54) Lashing Platform

(75) Inventor: Wolfgang Hahmann, Kempen (DE)

(73) Assignee: HYDAC SYSTEM GMBH, Sulzbach/Saar (DE)

(21) Appl. No.: 13/320,185

(22) PCT Filed: Apr. 22, 2010
(86) PCT No.: PCT/EP2010/002466

§ 371 Date: Jan. 31, 2012

(30) Foreign Application Priority Data
May 12, 2009 (DE) 10 2009 020 999.9

(51) Int. Cl. B23P 19/00

(52) U.S. Cl. 29/700

(57) ABSTRACT

The invention relates to a lashing platform for inserting and removing retaining hardware for twist-lock containers, having a dead plate for a container, the dead plate being supported on a rigid base by hydraulic displacers, and having a pressure medium store fluidically connected to the hydraulic displacers, wherein the hydraulic displacers under synchronized asymmetrical loading of the dead plate.

The invention relates to a lashing platform for inserting and removing twist-lock container securing fittings, having a dead plate for a container, the dead plate being supported on a rigid base by hydraulic displacers, and having a pressure medium store fluidically connected to the hydraulic displacers.

When loading or unloading container ships or other container transporting devices, so-called twist locks are used, inserted into corresponding recesses, preferably inserted at the corner areas of the container, to connect these with a parking position or to each other or also suspended from a crane. With a view to this task there is the demand to quickly fit twist locks, that are not part of the container, quickly release them again from the container during non-use to store them safely until their next use so that they do not become dirty or become lost. These procedures are carried out by workers that carry out the corresponding manual movements of removing, tensioning and attaching on the other containers while in the process the containers as a rule are suspended from a crane at eye level. There is then in principle the problem that the workers are not allowed to step close to the container until it is stationary. Before this the space and the surrounding area in which the container is lowered are blocked for operating personnel. Furthermore in such setting-down methods the crane operator has to estimate at which height he is to lower the container so that manual access can be easily achieved. In the process he must then strongly reduce the lowering speed in steps if needed.

To counter these disadvantages described above, lashing platforms are known that exhibit a dead plate for a container plus corresponding guides for the container, eliminating the need for access to the area of a freely suspended container, and corresponding access, if at all, is only to be carried out in the direction of the dead plate. Locking and unlocking the twist locks is then performed automatically either by a hydraulic screwing device that is fitted with a piston and can be driven in such a way or in particular by means of a compressed-air operated screwing device (WO 2007/098749 A1) that is of similar design as the wheel-nut tools in motor garages. The twist locks can here rest in a receptacle that brings them, in each case counter to a spring force acting in the twist lock, into a twisted position in which they can be removed from the container. After twisting a twist lock end into a defined position the container can then be lifted off and the twist locks remain in the receptacle. As a result of magazines provided at the four corners of the container it is then possible when usually four twist locks are to be used to carry out the insertion in a fast and automated way.

It has now been shown that in particular when used in ports where heavy fork trucks drive around freely and cranes run on the quay in a manner bound to rails it is not easy to supply such a lashing platform with energy. Neither can power supply nor pneumatic lines be readily laid out in the port area since even when installed underground they would be exposed to considerable damaging stress by the heavy cranes, nor arranged differently, since then the free movement of handling devices such as fork trucks would be impaired. Further it also not possible to generate the required energy by means of an engine in a simple way since this would make necessary the constant supply with relevant fuels and an inordinate level of maintenance costs would be created for constant operation.

Furthermore lashing platforms are being used whose devices are actuated using a pneumatic or hydraulic drive that handle the twist locks. The drive energy required for this is provided by using the potential and/or kinetic energy of the load to be lowered during the lowering procedure of the container onto the lashing platform to generate compressed air that is stored in compressed-air reservoirs so as to use the stored pneumatic energy during the subsequent operation for removing or inserting the twist locks correspondingly for driving the tools necessary for this (screwing tools). It is also the use of hydraulic shock absorbers that is suggested to accomplish the lowering procedure of the containers with the goods contained therein in a manner that is as gentle as possible (WO 2007/098749 A1).

In principle however such automatic lashing platforms have the disadvantage that storing energy efficiently can become problematic in the case of an asymmetric load distribution in the container since corresponding losses have to be expected during operation. Also the known technical designs of the devices for reclaiming energy (recuperation) are little optimised in such lashing platforms with regard to converting the potential energy of the container into another form of energy, for example kinetic energy.

The invention is therefore based on the object of proposing a lashing platform that enables efficient energy generation independently of the load situation and the load distribution.

These object is achieved by a lashing platform with all features of Patent claim 1.

According to the invention the lashing platform is provided with means for causing synchronous running in the sense of a dead platform that lowers parallel to the ground, and further has means that enable pressure transformation of the hydraulic fluid to the respective store as a function of the load of the container.

The amount of available energy is governed by the size of the load to be lowered and the lowering path that can be used for this. The size of the load to be lowered is here determined by the weight of the container and of the container transport system, the so-called spreader, that, lashed to hoisting equipment of the crane, serves for transport handling the respective container. It is further requisite that lowering even of an empty container must be sufficient to carry out all necessary manipulations and settings on the twist locks. In the process the load change can change for all intents and purposes between a maximum and a minimum by more than 7.2 fold.

The means that are required and used for pressure transformation therefore must enable a pressure drop by the displacers for hydraulic fluid to the respective store that is as low-loss as possible and matched to the respective load present. The pressure drop should preferably be as low as possible in each case to avoid losses.

The requisite uniform lowering of the load is effected by means of a synchronizing system that is composed of a synchronizing shaft that couples all hydraulic displacers or in the simplest case a balancer shaft. In a first exemplary embodiment of the inventive lashing platform all hydraulic displacers have the same volumes and are designed as hydraulic working cylinders. The pressure on the store side of the respective pressure or hydro store used is here equal to the arithmetic mean of the pressures occurring on the side of the hydraulic displacers.

A pressure transformation, i.e. a free, stepless variability of the pressure on the side of the hydraulic displacers to match the load pressure that changes within wide ranges and the store pressure that likewise is changeable is therefore requisite in the case of a preferred design. For the task in this direction selector valves are particularly suited that can be used to divert individual volume streams, coming from the displacers, without pressure to a tank instead of to the store. Here the hydraulic displacers that are switched for emptying into the tank drive, via the synchronizing shaft, the displacer(s) connected for pressurizing the store; at the same time the volume stream to the store is reduced. Since the power added is equal the power removed and the same energy is transferred to the reduced volume stream, the pressure of the volume stream as the working medium flowing to the store is increased to this extent. In this way the pressure of the emerging volume stream can be increased in steps selectively to the pressure of the added volume stream. For example in the case of displacers that are used three selector valves can be provided that cause a pressure transformation in the ratio 4:1 when connected to the tank.

Further pressure increases or the generation of considerably higher pressures however require other technical measures such as using one or more constant hydraulic displacers by such hydraulic displacers with a variable displacement that can be driven by the dead plate and/or the synchronizing shaft. To effect a reduction in pressure for example in the case of an empty store it can be provided to connect a selector valve relative to a displacer such that it evacuates hydraulic fluid from the tank and conveys it to the pressure store at maximum production rate. Again a maximum increase in pressure to the store is achieved in that all constant displacers are switched to delivery into the tank and the production rate of the hydraulic displacers with variable production volume is reduced.

According to the invention means are provided for damping and braking the stroke movement up to standstill at the stroke end of the hydraulic displacers designed as hydraulic cylinders. Here the hydraulic cylinders are preferably designed with a hollow piston as displacer piston into which a damping baffle tube protrudes that is fastened to the cylinder floor and is surrounded in the style of a valve piston in the wider part of the hollow piston by the latter. The damping baffle tube exhibits over its length openings with a defined size and spacing. When the hollow piston moves down in the cylinder, it displaces hydraulic fluid out of its cylinder space which gets through the openings into the interior of the damping baffle tube and from there to a pressure compensator.

As soon as the piston is in the upper dead position, very many openings are available for discharging the hydraulic fluid, that are covered more and more when the piston enters and are closed to this extent. In total in this way the flow area as sum of the openings in the damping baffle tube decreases in one direction, in particular in a vertical lower direction when installed as normal. This effects a desired speed profile of the movement of the dead plate after lowering a container onto the plate, the speed of the driving movement gradually approaching zero. The pressure compensator co-operates with the damping baffle tube like a two-way flow regulating valve that regulates the volume stream, with a metering orifice position that changes as a function of the stroke. If the speed of the dead plate acting on the piston of the cylinder deviates from the predetermined speed profile, then in the case of a speed that is lower than the desired speed there is an automatic matching to this desired value. If the speed is higher than corresponding to the profile the pressure compensator will close further and thus cause a higher pressure head. If the pressure head upstream of the pressure compensator should exceed the pressurization pressure of the damping store, hydraulic fluid is diverted into the store.

So that the dead plate can always return into the upper starting position after a container is removed, there is installed for the preferential supply of this system a separate store circuit that also operates with separate hoisting cylinders. In the working phase the volume stream is metered to equally adjusted flow regulating valves that thus also provide for the synchronization during the actual hoisting procedure.

The invention is described below using exemplary embodiments shown in the drawing. Here in a principle and not a representative illustration,

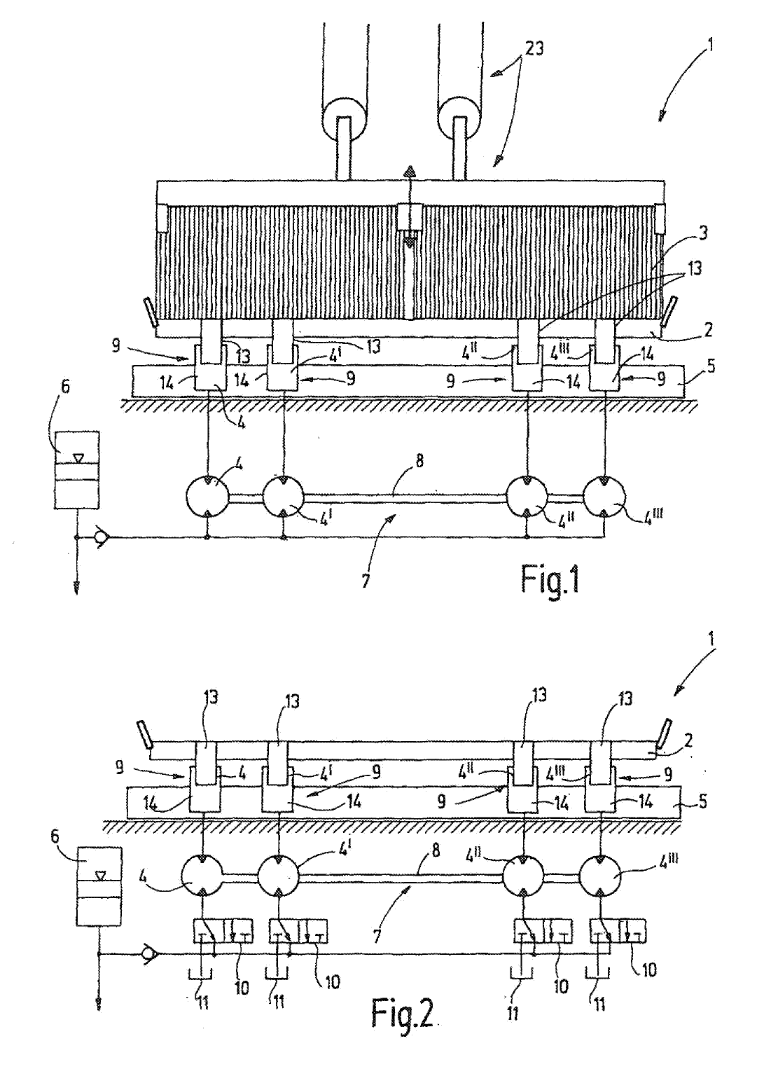

FIG. 1 shows a schematic view and a circuit diagram of a first exemplary embodiment of a lashing platform with means for synchronizing hydraulic displacers for the dead plate;

FIG. 2 shows a schematic view and a circuit diagram of a second exemplary embodiment of a lashing platform with selector valves for loss-free pressure increase of the store-filling pressure;

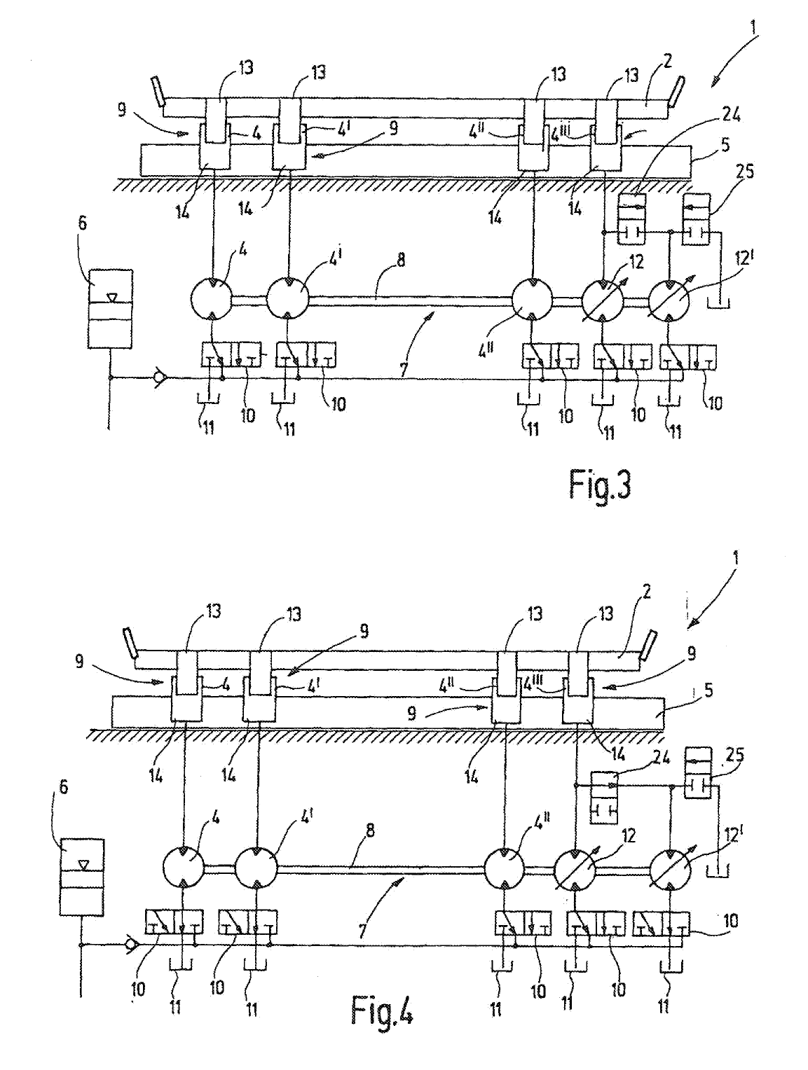

FIG. 3 shows a schematic view and a circuit diagram of a third exemplary embodiment of a lashing platform with hydraulic displacers with a constant and variable displacement and further means for synchronizing the dead plate;

FIG. 4 shows a schematic view and a circuit diagram of a fourth exemplary embodiment of a lashing platform with displacers with constant and variable displacement and switchable valves for increasing the pressure by a factor between 2 and 4;

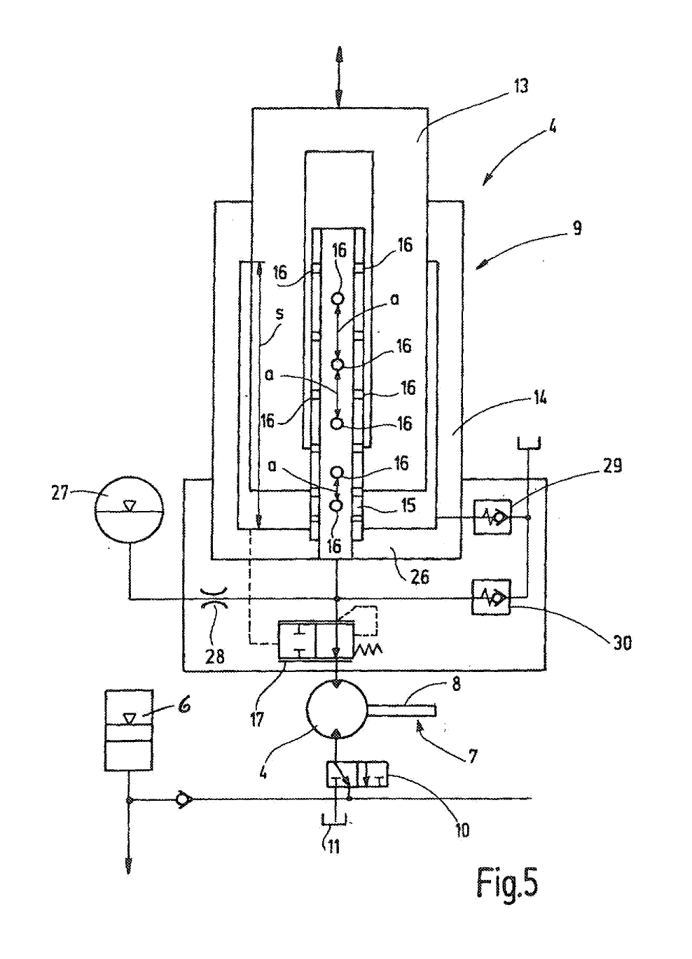

FIG. 5 shows a schematic longitudinal section and a circuit diagram through a working cylinder with hollow piston for damping the lowering movement of the dead plate shown above; and

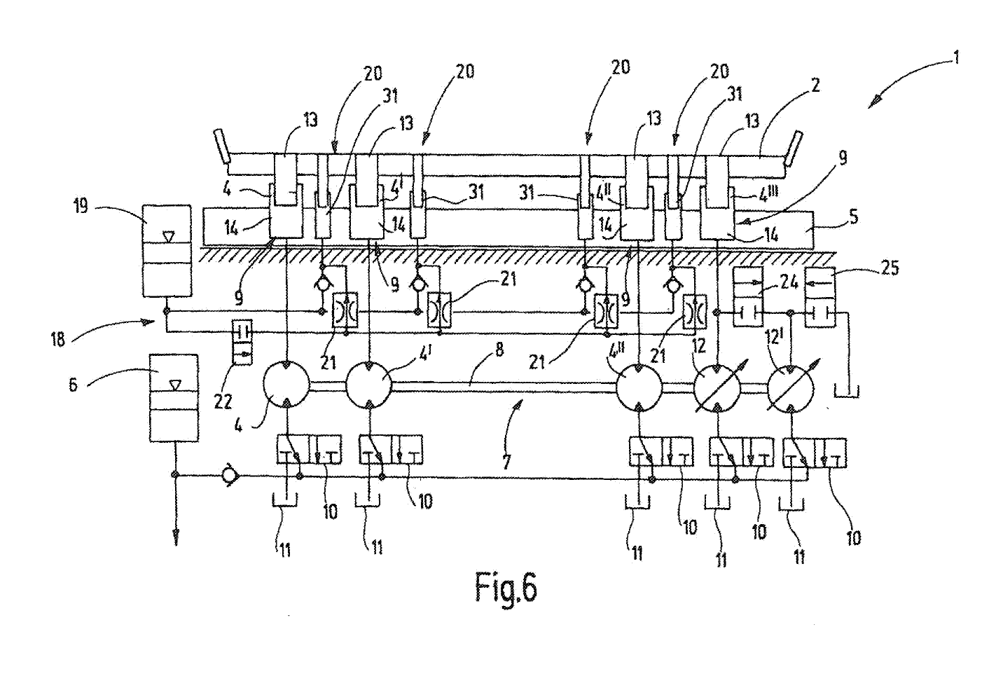

FIG. 6 shows a schematic view and a circuit diagram of a fifth exemplary embodiment of a lashing platform with hoisting means for the dead plate.

FIG. 1 shows a schematic view of a lashing platform 1 for a container 3 that is suspended from hoisting equipment 23. The lashing platform 1 serves in a manner known per se for releasing and/or attaching connecting means to the container 3 for subsequently locking it to further containers 3, a ship's bottom or the like. The lashing platform 1 essentially consists of a flat, preferably rectangular dead plate 2 for lowering the container 3 that is supported at a base 5 with hydraulic displacers 4 in between. The dead plate 2 is in general a steel-frame construction with receptacles for positively releasably receiving a container 3 to be handled.

The hydraulic displacers 4, 4′, 4″, 4′″ (represented below with the numeral 4) are designed in the exemplary embodiment shown as hydraulic working cylinders 9 that form a type of lowering system with the possibility for recovering energy. To provide the recovery of energy directly at the lashing platform 1 is preferably necessary for the reason that the lashing platform 1 is subject to frequent changes of location and the connecting means should be inserted and removed automatically which requires energy.

The amount of energy needed for this purpose is governed by the amount and type of required movement processes and the forces and moments to be exerted in the process when removing and inserting the connecting means that are called twist locks in the language of the experts, and their intermediate storage in magazines (not shown in more detail) of the lashing platform. Measurements have revealed that depending on the amount of force and movement, the required amount of energy for each removal and insertion of a twist lock is about 5 to 10 kNm. Thus a total amount of energy of 20 to 40 kNm is necessary for the four corners of a container. The amount of energy that can be generated is governed by the size of the load to be lowered and the lowering or setting-down path that can be used for the purpose. In any case, lowering a container by means of the hydraulic displacers 4 must be sufficient to carry out all necessary manipulations in the four corners of a container. A maximum load of some 900 kNm and a minimum load of some 125 kNm can be regularly assumed here.

The lashing platform 1 furthermore has a pressure medium store 6 for receiving hydraulic fluid displaced out of the displacers 4 during the lowering procedure. Of course instead of a pressure medium store 6 several pressure medium stores in the style of a storage battery can be used. In such a pressure medium store 6 a pressure prevails that is a function of the relevant load state. To shift energy into the pressure medium store 6, a pressure gradient is required from the displacers 4 to the pressure medium store 6 which, however, should preferably be small on account of the possible energy losses. To meet these boundary conditions it is indispensible to equalize the very eccentric centre of gravity of containers that often exists. To guarantee a lowering procedure that insofar runs parallel, differently than with lashing platforms according to the prior art, a synchronizing device is therefore provided. The synchronizing device shown in FIG. 1 has as means 7 for synchronizing a balancer shaft 8 to which all hydraulic cylinders 9 are connected and insofar coupled.

In addition to the balancer shaft 8 the lashing platform 1 shown in FIG. 1 has as means for pressure transformation, selector valves 10 using which individuals volume streams coming from the displacers 4 can be diverted without pressure into a fluid tank 11 instead of to the pressure medium store 6, making it possible to change the pressure conversion ratio. A selector valve 10 connected to the fluid tank 11 causes the relevant hydraulic displacer 4, coupled with the other hydraulic displacers 4, to drive the other hydraulic displacers by means of the balancer shaft 8. At the same time the volume stream to the pressure medium store 6 is reduced. Since the energy supplied is equal the energy discharged from this hydraulic system, a reduced volume stream effects an increase in pressure.

As a result of the arrangement shown in FIG. 2 the pressure of the exiting volume stream can thus be increased in steps. A loss-free decrease in pressure to the pressure medium store 6 or intermediate values for increasing the pressure in steps or to generate higher pressures than possible using the lashing platform 1 shown in FIG. 2 are achieved by the lashing platform according to the illustrations according to FIGS. 3 and 4.

The solutions, shown in FIGS. 3 and 4, of an inventive lashing platform are above all characterized in that a displacer with a constant displacement is replaced by two displacers 12, 12′ with a variable displacement. The displacer 12 exhibits an identical maximum displacement as a displacer 4 with a constant displacement, whereas a second displacer 12′ with a variable displacement can have an even greater displacement, as needed, as described above. The displacers 12, 12′ with variable displacement are arranged downstream of a hydraulic cylinder 9 and connected parallel thereto in a manner guiding fluids via a directional valve 24 and a directional valve 25. They are designed as variable pump-motor-units.

If it is intended to lower the pressure to the pressure medium store 6, the directional valve 25 is switched such that the variable hydraulic displacer 12′ as pump primes into the displacer strand from the fluid tank 11. In the process the displacer 12 remains at a setting with maximum displacement. By increasing the sum of the individual displacement streams to the pressure medium store 6 the pressure on the output side to the pressure medium store is insofar reduced. In this way much energy can be collected in the pressure medium store 6 when setting down big loads, and the operational phases where only empty or part-filled containers have to manipulated with very low energy yield can insofar use the stored energy for compensation purposes.

If however it is intended to increase the pressure to the pressure medium store 6 loss-free and without steps, according to the invention this is possible as follows. The directional valve 25 is closed, while the directional valve 24 is open. At the same time a selector valve 10 that connects the displacer 12′ to the pressure medium store 6 or the fluid tank 11 is adjusted such that the volume stream coming from the displacer 12′can flow off without pressure to the fluid tank 11. Then the displacer units 12, 12′ are adjusted such that, starting with a zero stroke volume or displacement of the displacer 12′ and the displacer 12 to a maximum value, the sum of the displacements of the displacers 12, 12′ constantly remains at the value of the other displacers 4. This is necessary for the desired synchronous running.

The required switching positions for the individual valves 10, 24 and 25 are shown in FIG. 4. The through-flow through the hydraulic displacers 4 with constant displacement 4, 4′and through the hydraulic displacer 12′ with variable displacement is diverted without pressure to the fluid tank 11. However the through-flow of the hydraulic displacer 4″ and 12 is directed to the pressure medium store 6. The hydraulic displacer 12 with variable displacement is for example adjusted to 60% of the maximum stroke volume of the hydraulic displacer 4″, and the hydraulic displacer 12′ is for example adjusted to 40% of the displacer 4″. In this way, of the 100% of the volume displaced by the hydraulic cylinders 9, after flowing through the displacers 60% are diverted to the fluid tank 11 and 40% are directed to the pressure medium store 6.

For damping and braking the insertion movement of the hydraulic cylinders 9 until standstill at the end of the stroke, they are fitted with supplementary devices, as is shown in an exemplary manner in FIG. 5. FIG. 5 shows a longitudinal section of a hydraulic cylinder 9 as displacer 4 with constant displacement. The hydraulic cylinder 9 exhibits a displacer piston 13 designed as a hollow piston that is guided axially slideable in a displacer cylinder 14 filled with a hydraulic fluid. Into the hollow piston a damping baffle tube 15 protrudes whose wall is interrupted by openings 16 that are always arranged in pairs at the same level. The distances a of the openings 16 are getting smaller in the direction to the cylinder floor 26 in which the damping baffle tube is fixed. When the hollow piston moves downwards in the displacer cylinder 14 it displaces hydraulic fluid from the cylinder space which passes through the baffle-like openings 16 into the interior of the damping baffle tube 15 and flows from there to a pressure compensator 17 acting as a meter-out pressure compensator. If the stroke piston is in the top dead-point position, very many openings 16 are available for the throughflow of the hydraulic fluid from the cylinder interior into the damping baffle tube 15. However the entering piston 13 covers more and more openings 16 so that the throughflow area as a sum of the openings 16 decreases in the downward direction. The position and size of the openings 16 is matched to the pressure compensator settings such that a defined desired speed profile results across the stroke height.

In the exemplary embodiment shown the speed profile is determined such that a constant deceleration results when the piston 13 enters, to be precise such that the stroke speed approximates zero at the end of the entering path s. In the process the pressure compensator 17 co-operates with the damping baffle tube 15 like a two-way flow regulating valve that regulates the volume, with a measurement-baffle setting that changes as a function of the stroke. The pressure compensator 17 opens on a low control pressure and closes on higher control pressures. Should the control pressure in the space upstream of the pressure compensator 17 exceed the pressurization pressure of a damping store 27, the damping store 27 takes up hydraulic fluid, a baffle or orifice 28 connected upstream of the store causing a damping effect on the movement sequence, thus damping oscillations in the system.

Using a filling valve 29, the filling of the cylinder space and using a further filling valve 30 the inside of the hollow piston can be filled with a defined amount of hydraulic fluid.

In the further exemplary embodiment shown in FIG. 6 the lashing platform 1 exhibits a separate store circuit 18 with a hoisting store 19 and hoisting means 20 designed as a hydraulic cylinder 31 to again lift the dead plate 2. The previous discussions also apply to the present exemplary embodiment, and the same components are provided with the same reference symbols as for the previous exemplary embodiments.

The hoisting store 19 is charged with energy when the dead plate 2 is lowered. In the hoisting phase of the dead plate 2 a hydraulic fluid or pressurized air from the hoisting store 19 is metered by means of identically adjusted flow dividers 21 until an even hoisting procedure is effected. In the case of the hoisting procedure, on the selector valve 22 between the hoisting store 19 and the flow dividers 19 it is brought into the open position. At the same time as the hoisting procedure also the hydraulic cylinders 9 are lifted and draw in hydraulic fluid from the fluid tank 11 by means of the filling valves 29, 30 shown in FIG. 5.

1. A lashing platform for inserting and removing twist lock container securing fittings with a dead plate for a container, the dead plate being supported on a rigid base by hydraulic displacers, and having a pressure medium store fluidically connected to the hydraulic displacers, characterized in that the lashing platform has means for synchronizing the hydraulic displacers under asymmetrical loading of the dead plate.

2. The lashing platform according to claim 1, characterized in that the means for synchronizing the hydraulic displacers makes possible a pressure transformation of hydraulic fluid to the pressure medium store to higher or lower pressures.

3. The lashing platform according to claim 1, characterized in that the means for synchronizing the hydraulic displacers comprise a balancer shaft for coupling the hydraulic displacers.

4. The lashing platform according to claim 1, characterized in that the hydraulic displacers are hydraulic cylinders.

5. The lashing platform according to claim 2, characterized in that the means for pressure transformation are formed by selector valves that conduct hydraulic fluid to the pressure medium store or to a fluid tank.

6. The lashing platform according to claim 5, characterized in that four hydraulic displacers and up to three selector valves are provided to establish pressure transformation up to a ratio of 4:1.

7. The lashing platform according to claim 1, characterized in that the means for synchronizing the hydraulic displacers comprise one or more additional hydraulic displacers with a variable displacement.

8. The lashing platform according to claim 7, characterized in that a pressure transformation of hydraulic fluid from the hydraulic displacers to the pressure medium store is effected by increasing or reducing a volume stream of the one or more additional hydraulic displacers with a variable displacement by means of a displacement of the hydraulic displacers with constant displacement in the direction of a lower or higher pressure.

9. The lashing platform according to claim 7, characterized in that a pressure transformation of hydraulic fluid from the hydraulic displacers and the one more additional hydraulic displacers to the pressure medium store is effected in the sense of increasing the pressure by matching a total volume stream of the one or more additional hydraulic displacers with a variable displacement to the hydraulic displacers with constant displacement.

10. The lashing platform according to claim 1, characterized in that the lashing platform exhibits means for damping the insertion movement of the dead plate.

11. The lashing platform according to claim 10, characterized in that the means for damping the insertion movement are formed by one or more displacer pistons that exhibit hydraulic fluid inside and are guided in a sliding fashion in a displacer cylinder on a damping baffle tube that exhibits openings for discharging hydraulic fluid from the displacer piston, that are closed when the at least one insertion path of the dead plate increases.

12. The lashing platform according to claim 11, characterized in that a size of the openings and the distances between the openings are chosen such that a defined speed profile is obtained by means of the at least one insertion path.

13. The lashing platform according to claim 11, characterized in that, when a displacer piston of the one or more displacer pistons moves into its end position, a stroke speed of the dead plate approaches zero.

14. The lashing platform according to claim 7, characterized in that, in the case of a setting-down procedure of a container on the dead plate, a stream of hydraulic fluid discharged from the hydraulic displacers and the one or more additional hydraulic displacers is regulated by a pressure compensator such that a defined speed profile of the insertion procedure is effected.

15. The lashing platform according to claim 14, characterized in that the speed profile is independent of load conditions of the container and a setting-down speed onto the dead plate.

16. The lashing platform according to claim 14, characterized in that on exceeding a control pressure upstream of the pressure compensator to values that are higher than a pressurization pressure of the pressure medium store, hydraulic fluid is introduced into the pressure medium store.

17. The lashing platform according to claim 1, characterized in that a store circuit with a store and a hoisting means for hydraulically hoisting the dead plate is arranged in the lashing platform.

18. The lashing platform according to claim 17, characterized in that the hoisting means is connected to the store by means of a flow divider and a selector valve.
